(19) United States
(12) Patent Application Publication
(10) Pub. No.: US 2005/0015731 A1
(43) Pub. Date: Jan. 20, 2005

(54) Handling data across different portions or regions of a desktop

(75) Inventors: William Mak, Seattle, WA (US); Grady Leno, Seattle, WA (US); Michael Hin-Cheung Tsang, Bellevue, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/619,174

(22) Filed: Jul. 15, 2003

(51) Int. Cl. G09G 5/00

(52) U.S. Cl. 715/779; 715/778; 715/764

(57) ABSTRACT

Systems, methods, computer-readable media, and user interfaces for entering, handling, or manipulating data on a computer desktop may include: (a) providing a first viewable region capable of displaying a first portion of a desktop on a display device; and (b) providing a second viewable region capable of displaying a second portion of the desktop on the display device, wherein a portion of the first viewable region redirects data input to and associates the data input with the second portion of the desktop. Other systems, methods, computer-readable media, and user interfaces may include: (a) maintaining a first portion of a desktop; (b) maintaining a second portion of the desktop, wherein the second portion of the desktop includes a region representing the first portion of the desktop; and (c) altering content of the first and/or second portions of the desktop in at least some instances based on data input directed to the region. The desktop portions or regions may be displayed by separate display devices, in some examples, wherein one display device displays a region that represents the content displayed by the other display device.

### FIELD OF THE INVENTION

This invention generally relates to systems, methods, user interfaces, and computer-readable media for handling, entering, or manipulating data across different portions or regions of a computer desktop. For example, at least some examples of this invention include the ability to alter the content of a first portion or region of a desktop from a second, independent portion or region of the desktop.

### BACKGROUND

As a result of technological advancements and consumer demand, personal computer systems today are more flexible, versatile, and user-friendly than ever. Today, computer users are able to simultaneously run multiple application programs, open and use multiple electronic documents, and move between different programs and/or documents with a simple mouse click or other input action.

Because computers are able to simultaneously run multiple application programs and allow interaction with multiple electronic documents, the ability to organize and present the available information to users in a convenient and useful manner is an important aspect of a computer system. Some computer systems utilize an “electronic desktop” to organize information available on a computer and present this information to the computer user. FIG. 1 illustrates an example representation of an electronic desktop 10. An electronic desktop (or “desktop”) of this type typically provides icons, windows, files, or other representations of various application programs, electronic documents, and the like that are stored on and/or available through the computer. Such icons, windows, files, or visual representations are illustrated in FIG. 1 at reference number 12.

FIG. 1 illustrates additional advantageous features of at least some computer systems and desktops that further improve their usefulness and flexibility. As illustrated, in some systems, a single computer system can operate in conjunction with multiple monitors or other suitable display devices (e.g., Monitors A-F in FIG. 1), and different portions of the electronic desktop 10 may appear on the different monitors or display devices. By using multiple monitors or display devices, a computer user can simultaneously view and interact with different portions of the desktop 10.

FIGS. 1 and 2 illustrate a conventional way that multiple monitor users might move data between one portion of the desktop and another portion of the desktop. For example, as illustrated in FIG. 1, in some instances a user may desire to move certain data (e.g., the data represented by icon 14) from its original position on the desktop (e.g., on Monitor A (shown in broken lines)) to a new location on the desktop (e.g., on Monitor B). This movement is illustrated in FIG. 1 by arrow 16. In conventional systems, as shown in FIG. 2, this data transfer may be completed using a mouse 18 (or other similar user input device). Specifically, a user first selects the data set to be moved (e.g., by a right button click action), and while holding the button down, the user begins dragging the icon or visual representation 14 across the desktop as displayed on Monitor A. In FIG. 2, the original location of the mouse 18, like the original location of icon 14, is shown in broken lines. The first step of mouse 18 movement and icon 14 movement are shown in FIG. 2 by the arrows labeled “1” (for the first step). In some instances, movement during this first step will not be sufficient to place the icon 14 at the desired location on the desktop (on Monitor B, in this example). For example, as shown in FIG. 2, the first step leaves the icon 14 at location 20, still appearing on Monitor A. In this event, as a second step, the mouse 18 can be lifted and moved back to the left, as shown by arrow 2 in FIG. 2. During this mouse 18 movement, the icon 14 remains at location 20, as illustrated by the circled “2” above icon 14 at location 20. Then, during a third step, the mouse 18 can again be moved to the right, as indicated by the arrow 3, until icon 14 arrives at the desired location on the desktop (appearing on Monitor B, in this example). This procedure can be repeated as often as necessary (and in any direction necessary) in order to place the icon at any desired location on the desktop. This procedure also can be performed using other input devices, such as touchpads, rollerballs, trackballs, and the like.

Because a mouse is a relative pointing device, it can be lifted and moved during the procedure described above in order to make long movements across the desktop (if necessary). Not all computers, however, use a mouse type pointing device. Rather, recently, pen-based computing systems have become popular. Pen-based computing systems (like those described in more detail below in conjunction with FIGS. 4 and 5) allow users to enter data and control the user interface using an electronic pen, stylus, or other suitable user input device.

Difficulties arise, however, when users attempt to use pen-based computing systems in multi-monitor mode like that described above in conjunction with FIGS. 1 and 2. Specifically, unlike a mouse, a pen is an absolute pointing device that locates a cursor and/or takes other action at the location where the pen interacts with a digitizer that typically forms part of the computer's display screen. If a monitor or other display device does not have a digitizer associated with it (and many do not), it is not able to accept user input from an electronic pen, and the pen is not able to manipulate data and operate in conjunction with such a monitor. Additionally, even if the computer system is operating in multi-monitor mode using two (or more) monitors or display devices that have digitizer screens, a pen is not capable of “carrying” the data through the air and over the space between the monitors. Accordingly, when using a pen-based computing system, data cannot be moved from one portion of a desktop to another independent portion of the desktop using a click and drag action (or tap and drag action) in the manner described above.

Another interesting use also applies to traditional mice. Conventional multi-monitor traversal occurs by “warping” from the edge of one desktop/monitor pair to the edge of another desktop/monitor pair. This gives the illusion of panning smoothly across multiple monitors that are, for instance, arranged side-by-side. Panning to the right edge of the monitor on the left “warps” the mouse to the left edge of the monitor on the right. This behavior works because of an explicit action taken by the user to configure the operation system to understand the physical relationship of the monitors. If the monitors do not live in the same planar relationship, like a laptop in a conference room with a 2^{nd} desktop projecting on the conference room screen, it is impossible to create the same illusion since the monitors have a 3-dimensional relationship rather than a flat planar relationship.

Accordingly, at least some aspects of the present invention seek to enable data entry, manipulation, and handling in pen-based computing systems operating an electronic desktop in a multi-monitor mode. Additionally, advantageous aspects of this invention may be applied to computer systems that operate with user input devices other than electronic pens, such as mice, trackballs, touchpads, rollerballs, eraser heads, keyboards, and the like. At least some aspects of the present invention allow a more natural user interface for manipulating multiple desktops that are being projected to non-planar monitors when using any type of user input devices, including traditional relative pointing devices, such as a mouse.

### SUMMARY

Aspects of the present invention generally relate to systems, methods, user interfaces, and computer-readable media for entering, handling, or manipulating data on a computer or electronic desktop. As one example, aspects of this invention may include systems, methods, and user interfaces that: (a) provide a first viewable region capable of displaying a first portion of a desktop on a display device; and (b) provide a second viewable region capable of displaying a second portion of the desktop on the display device, wherein a portion of the first viewable region redirects data input to and associates the data input with the second portion of the desktop. Other example aspects of this invention relate to systems, methods, and user interfaces that include: (a) maintaining a first portion of a desktop; (b) maintaining a second portion of the desktop, wherein the second portion of the desktop includes a region representing the first portion of the desktop; and (c) altering content of the first and/or second portion of the desktop in at least some instances based on data input directed to the region. Still additional example aspects of this invention relate to systems, methods, and user interfaces that include: (a) displaying a first portion of a desktop by a first display device; (b) displaying a second portion of the desktop by a second display device, wherein at least a portion of a display by the second display device includes a region representing the first display device; and (c) altering content displayed by the first display device in at least some instances based on data input directed to the region representing the first display device. Example aspects of this invention also relate to computer-readable media having stored thereon computer-executable instructions for performing various methods, including the methods described above and including methods for operating systems and generating user interfaces like those described above.

### BRIEF DESCRIPTION OF THE DRAWINGS

The foregoing summary of aspects of the invention, as well as the following detailed description of various examples, is better understood when read in conjunction with the accompanying drawings, which are included by way of example, and not by way of limitation with regard to the claimed invention. In the figures:

FIG. 1 conceptually illustrates an electronic desktop that aids in understanding aspects of the present invention;

FIG. 2 illustrates a conventional manner in which objects are moved from one portion of a desktop to another;

FIG. 3 illustrates an example general-purpose computer that may be used in accordance with aspects of the present invention;

FIG. 4 illustrates a display for an example pen-based computing system that may be used in accordance with aspects of the present invention;

FIG. 5 illustrates hardware useful in practicing aspects of the present invention;

FIGS. 6a through 6c illustrate various features available in at least some examples of systems and methods according to the invention;

FIGS. 7a and 7b illustrate additional features available in at least some examples of systems and methods according to the invention;

FIGS. 8a and 8b illustrate additional features available in at least some examples of systems and methods according to the invention;

FIGS. 9a and 9b illustrate additional features available in at least some examples of systems and methods according to the invention;

FIGS. 10a and 10b illustrate an example of movement of data from one portion of a desktop to another in at least some examples of systems and methods according to the invention; and

FIG. 11 includes a flowchart describing operation of some examples of systems and methods according to the invention.

### DETAILED DESCRIPTION OF THE DRAWINGS

Various specific examples of the invention are described in detail below in conjunction with the attached drawings. To assist the reader, this specification is broken into various subsections, as follows: Terms; General Description of Handling Data Across Different Portions or Regions of a Desktop; Example Hardware Useful with the Invention; Specific Examples of the Invention; and Conclusion.

A. Terms

The following terms are used in this specification, and unless otherwise noted or clear from the context, these terms have the meanings provided below.

Desktop—An arrangement or on-screen display of icons or other representations of various application programs, electronic documents, and the like that are stored on and/or available through a computer system. In some instances, an individual display device may display only a portion of an electronic desktop, and in some instances, various independent portions of the desktop may be displayed by multiple display devices operated by a common computer system.

Viewable region—An area or portion of a monitor or other display device that displays or provides user access to all or some of the desktop.

User interface—The combination of menus, screen design, user input commands, command language, help screens, and/or the like that create the way in which a user interacts with a computer system. User input devices (such as pens, mice, touch screens, touchpads, keyboards, rollerballs, trackballs, and the like) also may be included.

Jump pane—A portion of a user interface providing a portal that allows users to enter, move, or otherwise manipulate or handle data located in one portion of a desktop from a second, independent portion of the desktop.

Display device—Any device that displays or renders information and/or generates data that enables a display or rendering of information. Display devices include, but are not necessarily limited to monitors, projectors, screens, and the like.

“Render” or “Rendered” or “Rendering”—The process of determining how information (including text, graphics, and/or electronic ink) is to be displayed, whether on a screen, printed, or output in some other manner.

“Computer-Readable Medium”—Any available media that can be accessed by a user on a computer system. By way of example, and not limitation, “computer-readable media” may include computer storage media and communication media. “Computer storage media” includes volatile and nonvolatile, removable and non-removable media implemented in any method or technology for storage of information, such as computer-readable instructions, data structures, program modules, or other data. “Computer storage media” includes, but is not limited to: RAM, ROM, EEPROM, flash memory or other memory technology; CD-ROM, digital versatile disks (DVD) or other optical storage devices; magnetic cassettes, magnetic tape, magnetic disk storage or other magnetic storage devices; or any other medium that can be used to store the desired information and that can be accessed by a computer. “Communication media” typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared and other wireless media. Combinations of any of the above should also be included within the scope of “computer-readable media.”

B. General Description of Hanlding Data Across Different Portions or Regions of a Desktop

In general, this invention relates to systems, methods, user interfaces, and computer-readable media for handling data with respect to a computer desktop. One more specific aspect of this invention relates to methods for providing user interfaces. As one example, methods according to this aspect of the invention may include: providing a first viewable region capable of displaying a first portion of a desktop on a display device; and providing a second viewable region capable of displaying a second portion of the desktop on the display device, wherein a portion of the first viewable region redirects data input to and associates the data input with the second portion of the desktop. In some examples of methods according to this aspect of the invention, user input is accepted, and at least some of the user input includes the data input that is redirected to the second portion of the desktop.

Another example aspect of this invention relates to methods that include: displaying a first portion of a desktop using a first display device; displaying a second portion of the desktop using a second display device, wherein at least a portion of a display by the second display device includes a region representing the first display device; and altering content displayed by the first display device in at least some instances based on data input directed to the region representing the first display device.

Still another example aspect of this invention relates to methods that include: maintaining a first portion of a desktop; maintaining a second portion of the desktop, wherein the second portion of the desktop includes a region representing the first portion of the desktop; and altering content of the first and/or second portions of the desktop in at least some instances based on data input directed to the region.

Additional aspects of this invention relate to systems for handling data on a computer desktop, including, for example, systems for performing the various methods described above. Examples of such systems may include: a first display device displaying a first portion of a desktop; a second display device displaying a second portion of the desktop, wherein at least a portion of a display by the second display includes a region representing the first display device; and a processor programmed and adapted to alter content displayed by the first display device in at least some instances based on data input directed to the region representing the first display device. Other examples of such systems may include: a receiver constructed and adapted to receive input; and a processor programmed and adapted to: (a) maintain a first portion of a desktop; (b) maintain a second portion of the desktop, wherein the second portion of the desktop includes a region representing the first portion of the desktop; and (c) altering content of the first and/or second portion of the desktop in at least some instances based on data input directed to the region.

Still additional aspects of this invention relate to user interfaces for interacting with a desktop on a computer screen or other display device. For example, user interfaces according to some examples of this invention may be displayed by a display device and include: a first region representing a first portion of a desktop; a second region representing a second portion of the desktop; and a data transfer path or portal that allows data to be transferred between the first region and the second region.

Input can be introduced into systems and methods according to examples of this invention in any suitable manner. For example, in at least some instances, the data input transferred across different portions or regions of the desktop may constitute user input introduced via a suitable user input device, such as a pen (or stylus), a mouse, a trackball, a rollerball, a touch pad, a touch screen, a keyboard, or the like.

As generally described above, at least some aspects of this invention relate to systems and methods wherein data is movable between different regions or portions of a desktop such that one portion or region on the desktop may be altered by a user through another portion or region of the desktop. Altering the content in a first desktop portion or region may include, for example, altering the content displayed by a display device for the first desktop portion or region or otherwise altering the stored content associated with the first desktop portion or region. Altering the content displayed by a display device may include, for example, determining at least a first coordinate of a second desktop portion or region associated with the data input to be redirected to the first desktop portion or region, and remapping the first coordinate to a corresponding coordinate of the first desktop portion or region.

Additional aspects of this invention relate to computer-readable media having stored thereon computer-executable instructions for performing various methods, including the methods described above and including suitable methods for operating systems and generating user interfaces like those described above.

Various aspects and examples of the present invention will be described in detail below in conjunction with the attached figures. The description and figures should be construed as examples of the invention and not as limitations on the invention.

C. Example Hardware Useful with the Invention

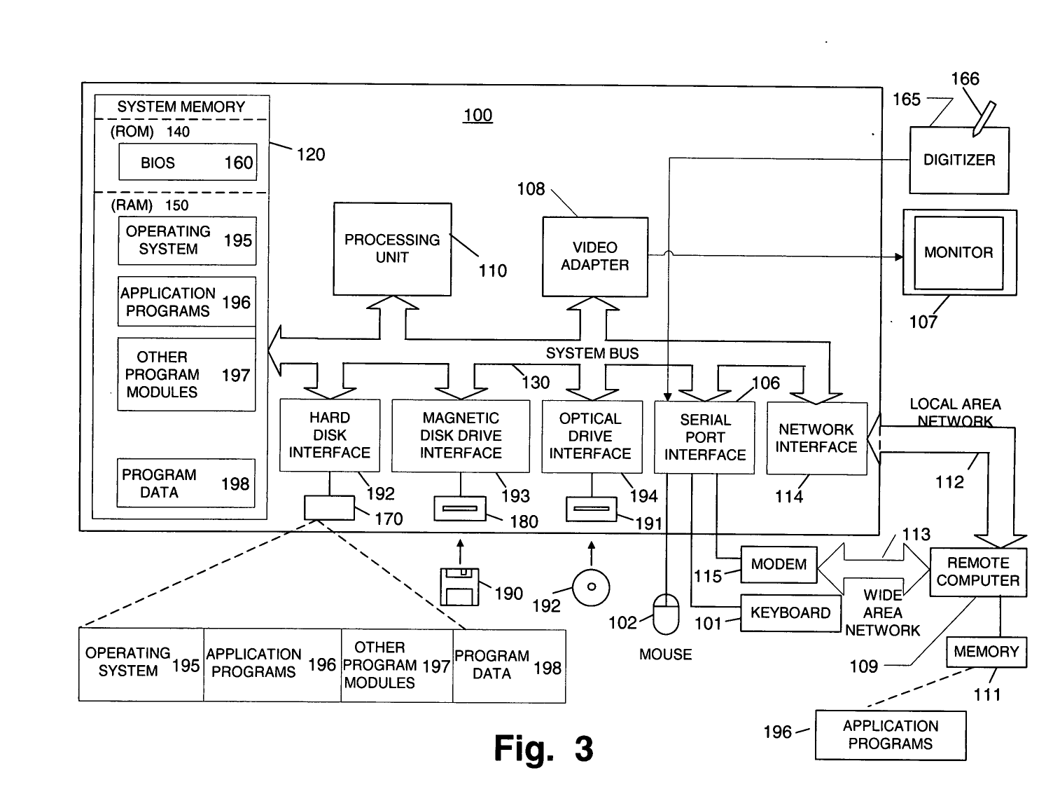

FIG. 3 illustrates a schematic diagram of an illustrative example general-purpose digital computing environment that can be used to implement various aspects of the present invention. In FIG. 3, a computer 100 includes a processing unit 110, a system memory 120, and a system bus 130 that couples various system components, including the system memory 120, to the processing unit 110. The system bus 130 maybe any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS) containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100. It will be appreciated by those skilled in the art that other types of computer-readable media that can store data that is accessible by a computer, such as magnetic cassettes, flash memory cards, punch cards, digital video disks, Bernoulli cartridges, random access memories (RAMs), read only memories (ROMs), and the like, also may be used in the example operating environment without departing from the invention.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices, such as a keyboard 101 and a pointing device 102. Other input devices (not shown) may include a microphone, joystick, game pad, satellite dish, scanner, or the like. These and other input devices often are connected to the processing unit 110 through a serial port interface 106 that is coupled to the system bus, but they may be connected by other interfaces, such as a parallel port, game port, a universal serial bus (USB), or the like. Further still, these devices may be coupled directly to the system bus 130 via an appropriate interface (not shown). A monitor 107 or other type of display device also is connected to the system bus 130 via an interface, such as a video adapter 108. In addition to the monitor 107, personal computers typically include other peripheral output devices (not shown), such as speakers and printers. In one example, a pen digitizer 165 and accompanying pen or stylus 166 are provided in order to digitally capture freehand electronic ink input. Although a direct connection between the pen digitizer 165 and the serial port interface 106 is shown, in practice, the pen digitizer 165 may be coupled to the processing unit 110 directly, to a parallel port, to another interface, and to the system bus 130, as known in the art. Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as remote computer 109. The remote computer 109 can be a server, a router, a network PC, a peer device, or other common network node, and it typically includes many or all of the elements described above relative to the computer 100, although only a memory storage device 111 has been illustrated in FIG. 3. The example logical connections depicted in FIG. 3 include a local area network (LAN) 112 and a wide area network (WAN) 113. Such networking environments are commonplace in offices, enterprise-wide computer networks, intranets, and the Internet, using both wired and wireless connections.

When used in a LAN networking environment, the computer 100 may be connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external to the computer 100, maybe connected to the system bus 130 via the serial port interface 106. In a networked environment, program modules depicted relative to the personal computer 100, or portions thereof, may be stored in the remote memory storage device 111.

It will be appreciated that the network connections shown are illustrative and other techniques for establishing a communications link between the computers can be used. The existence of any of various well-known protocols such as TCP/IP, UDP, Ethernet, FTP, HTTP, and the like is presumed, and the system can be operated in a client-server configuration to permit a user to retrieve web pages from a web-based server. Any of various conventional web browsers can be used to display and manipulate data on web pages.

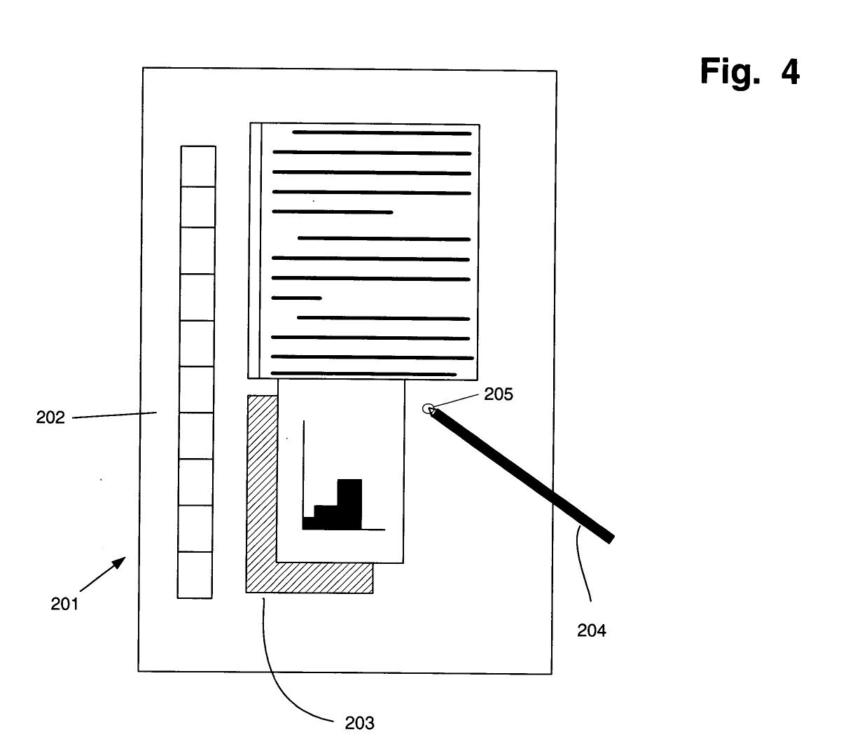

FIG. 4 illustrates an illustrative pen or stylus-based computing system 201 (e.g., a tablet PC, PDA, or the like) that can be used in accordance with various aspects of the present invention. Any or all of the features, subsystems, and functions in the system of FIG. 3 can be included in the computing system of FIG. 4. Pen or stylus-based computing system 201 includes a large display surface 202, e.g., a digitizing flat panel display, such as a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as pen digitizers available from Mutoh Co. (now known as FinePoint Innovations Co.) or Wacom Technology Co. Other types of pen digitizers, e.g., optical digitizers, also may be used. The pen or stylus-based computing system 201 interprets gestures made using stylus 204 in order to manipulate data, enter text, create drawings, and/or execute conventional computer application tasks, such as spreadsheets, word processing programs, and the like.

The stylus 204 may be equipped with one or more buttons or other features to augment its capabilities. In one example, the stylus 204 could be implemented as a “pencil” or “pen,” in which one end constitutes a writing portion and the other end constitutes an “eraser” end that, when moved across the display, indicates portions of the display to be erased. Other types of input devices, such as a mouse, a trackball, or the like could be used. Additionally, a user's own finger could be the stylus 204 and used for selecting or indicating portions of the displayed image on a touch-sensitive or proximity-sensitive display. Consequently, the term “user input device,” as used herein, is intended to have a broad definition and encompasses many variations on well-known input devices, such as stylus 204. Region 205 shows a feedback region or contact region permitting the user to determine where the stylus 204 has contacted the display surface 202.

In various examples, the system provides an ink platform as a set of COM (component object model) services that an application program can use to capture, manipulate, and store ink. The ink platform also may include a mark-up language including a language like the extensible markup language (XML). Further, the system may use DCOM as another implementation. Yet further implementations maybe used including the Win32 programming model and the .Net programming model from Microsoft Corporation. These platforms are commercially available and known in the art.

The invention now will be described in conjunction with the remaining figures, which illustrate various examples of the invention and information to help explain the invention. The specific figures and information contained in this detailed description should not be construed as limiting the invention.

D. Specific Examples of the Invention

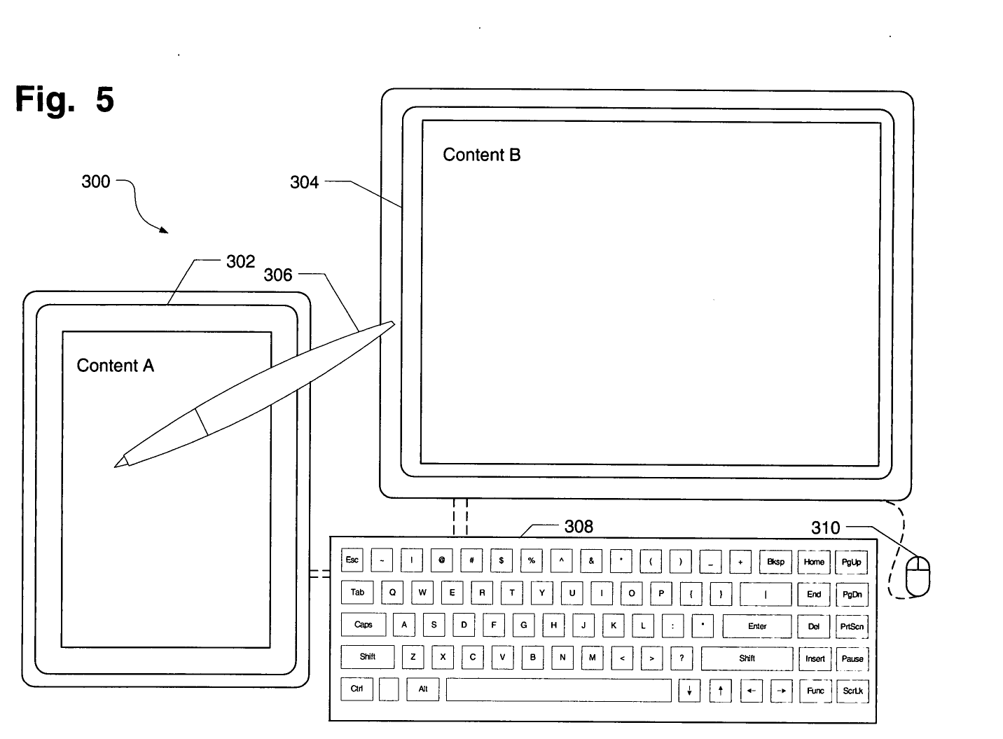

As described above, aspects of this invention relate to entering, moving, or otherwise manipulating data or content in a first portion or region of a desktop from a second, independent portion or region of the desktop. FIG. 5 generally illustrates an example of a system 300 that may be used in connection with examples of the present invention. Specifically, as illustrated in FIG. 5, the system 300 includes a first display device 302, a second display device 304 and a plurality of user input devices, namely, an electronic pen 306 (for entering electronic ink and/or controlling the interface associated with display device 302), a keyboard 308, and a mouse 310 (which includes within its scope a rollerball, a touchpad, a trackball, and the like). Systems according to the invention may use any one or all types of suitable user input devices, not limited to those specifically illustrated in FIG. 5. Connections between the keyboard 308, mouse 310, the display devices 302 and 304, and the computer processor (not shown) may be made in any suitable manner without departing from the invention, including conventional manners known to those skilled in the art, e.g., via wired connections or wireless connections.

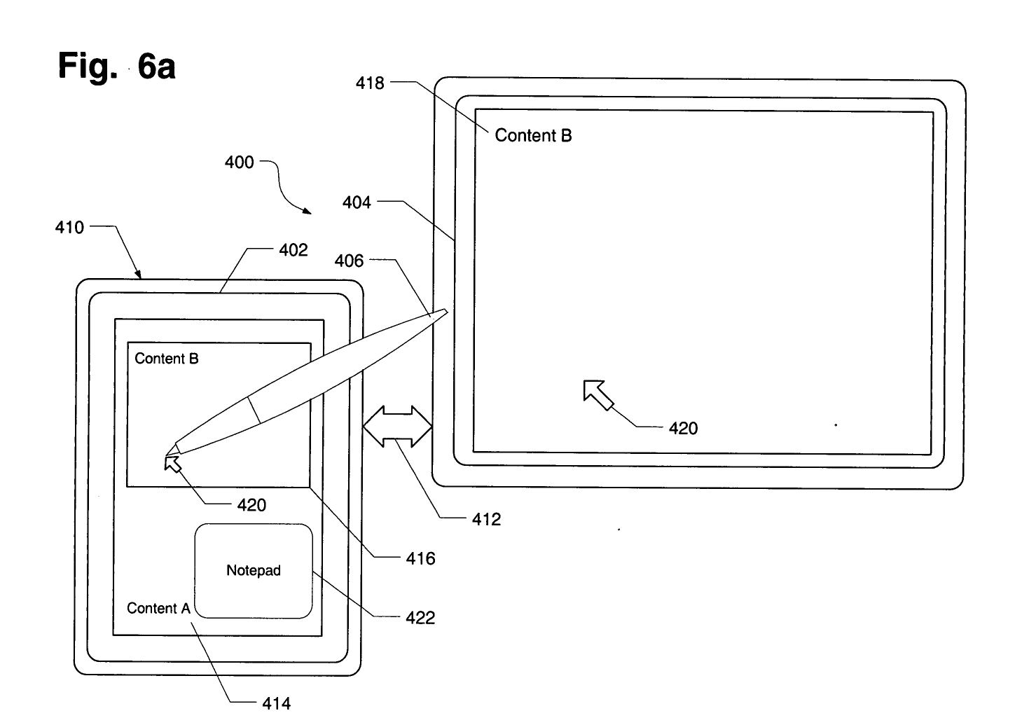

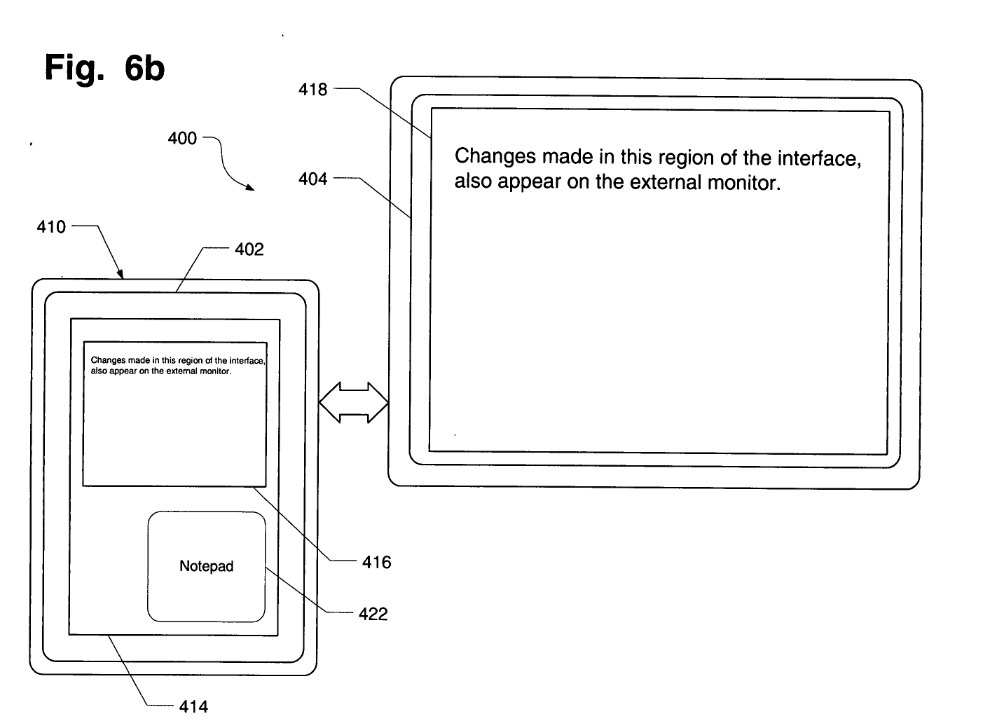

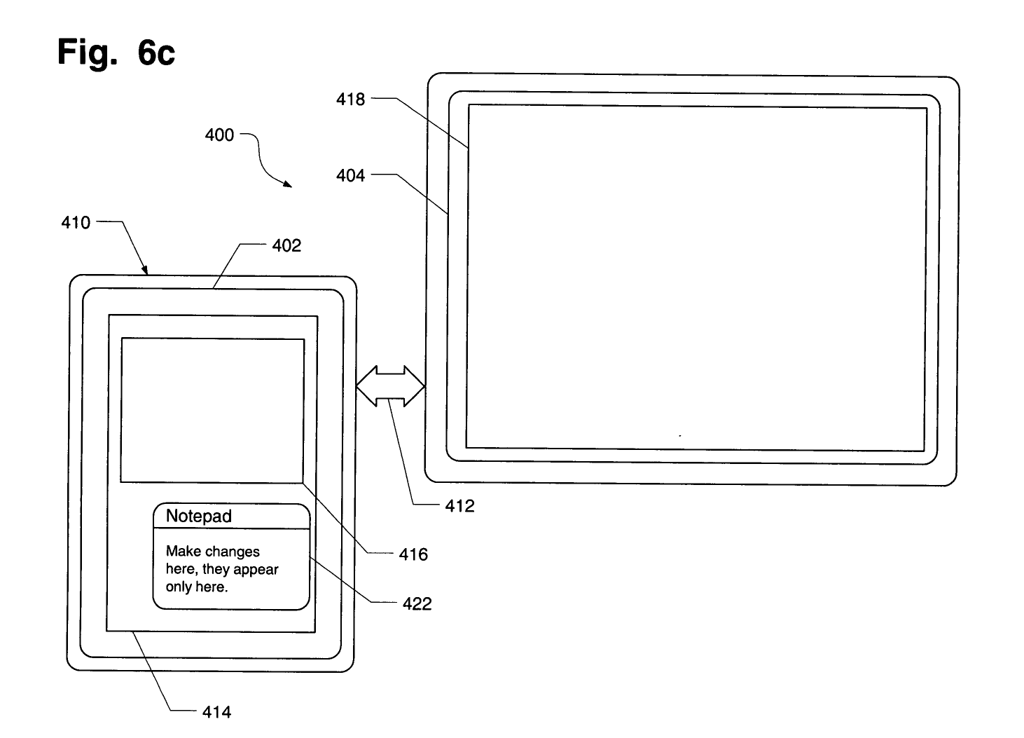

FIGS. 6a-6c illustrate an example system 400 in which a first display device 402 of the system forms a portion of a pen-based computing system 410, such as one like that described above in conjunction with FIG. 4, in which electronic ink and other input data may be entered into the system 400 (and the system 400 interface otherwise controlled) using a pen or stylus type input device 406. A first portion or viewable region 414 of a computer desktop may be displayed by the display device 402. The system 400 further includes a second display device 404, on which a second portion or viewable region 418 of the computer desktop may be displayed. This second display device 404 may be any desired type of device, including a monitor (with or without a digitizer); a projector for projecting an image onto a screen or a wall; or the like. Both the first display device 402 and the second display device 404 are operated using a common processor or computer screen, which in this example is the processor unit provided in the pen-based computing system 410. The connection of display device 404 to the processor of pen-based computing system 410 is illustrated in FIG. 6a by arrow 412, which denotes any suitable connection.

In the example illustrated in FIG. 6a-6c, display device 402 includes a first display area or viewable region 414 that displays a first portion of the computer desktop (identified as “Content A” in FIG. 6a) and a second display area or viewable region 416 that displays a second portion of the computer desktop (identified as “Content B” and including arrow 420 in FIG. 6a). Display device 404, in this illustrated example, includes a display area or viewable region 418 that also displays the second portion of the computer desktop (also identified as “Content B” and including arrow 420 in FIG. 6a). In this example, the content of the second display area or viewable region 416 of the first display device 402 and the display area or viewable region 418 of the second display device 404 mirror one another (although, in at least some instances, in different sizes). Additionally, in this example, changes made in or directed to display area or viewable region 416 of the first display device 402 (e.g., data entry, deletion, modification, etc.) also will be directed to and appear in display area or viewable region 418 of the second display device 404, as illustrated in FIG. 6b. These changes may include, for example, entry and manipulation of electronic ink. On the other hand, in this example of systems and methods according to the invention, changes made in or directed to display area or viewable region 414 of the first display device 402 (e.g., data entry, deletion, or modification) do not appear in the display area or viewable region 418 of the second monitor 404, as illustrated in FIG. 6c.

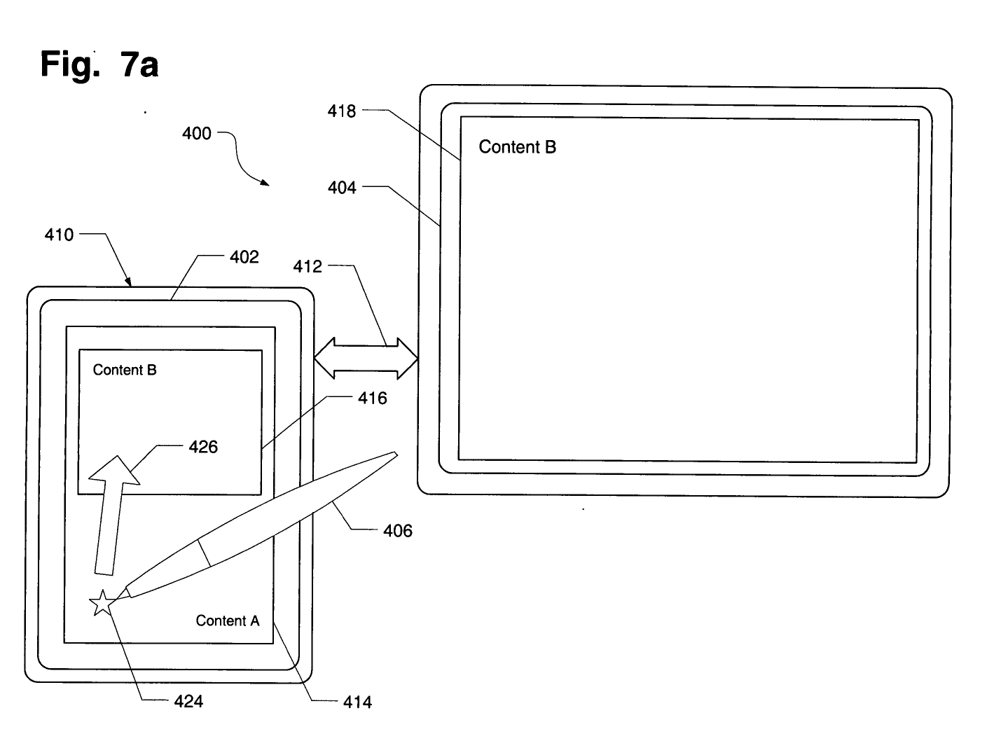

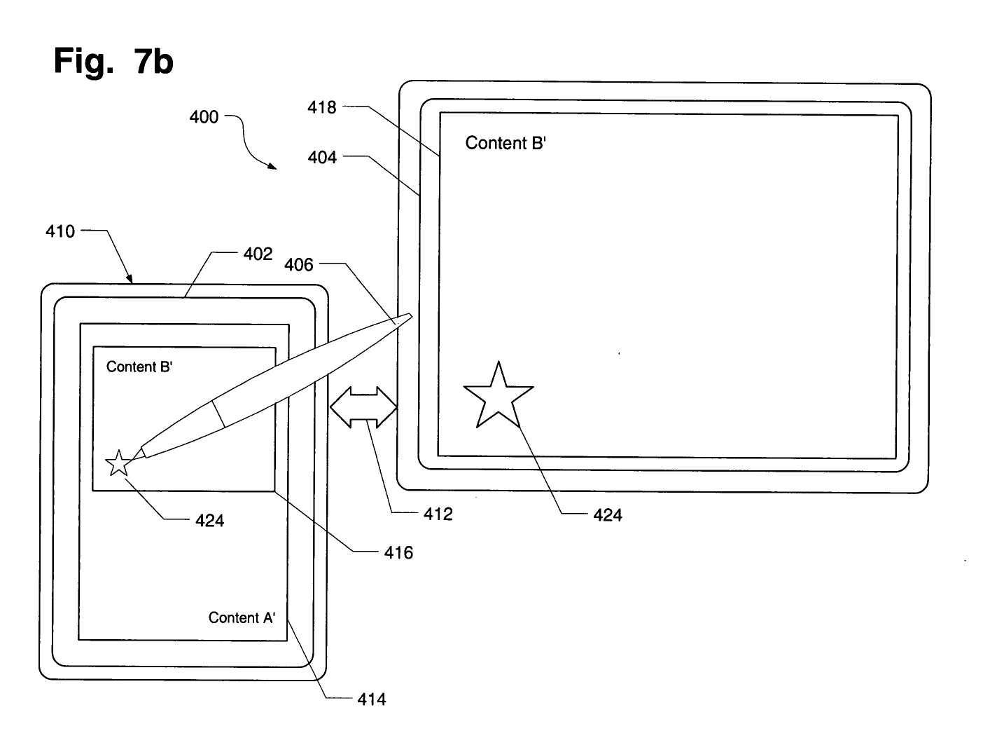

Changes to data and information contained within or directed to display area or viewable region 416 can be made in any suitable manner. For example, a user could enter new data, delete existing data, and/or modify existing data within display area or viewable region 416 using an input device, such as a pen 406, a mouse type device (not shown), or a keyboard (not shown). As another example a user could move data into display area or viewable region 416 from display area or viewable region 414 (or another portion or region of the desktop) using a “dragging” action (e.g., pen tap or selection and drag and/or mouse click or selection and drag). This feature is described in more detail in conjunction with FIGS. 7a and 7b.

FIGS. 6a and 6c illustrate another convenient feature useful in some examples of this invention. For example, the first portion or viewable region 414 of the desktop may include an area in which a user can enter data, such as an electronic notepad 422. Using a pen (or another suitable input device), a user can enter notes on the notepad 422. In at least some examples of the invention, as noted above, the data relating to these notes will not be located in the second portion of the desktop 416, and therefore, this information will not transfer to or appear on the other display device 404. However, if the user wanted the information in the notes 422 to appear on the other display device 404, the desired data could be moved to the second portion of the desktop 416, for example, by a drag and drop operation, by a copy operation, or in any other suitable manner, without departing from the invention.

FIGS. 7a and 7b illustrate a “dragging” operation useful to move data from the first portion of the desktop to the second portion of the desktop and vice versa. As shown in FIG. 7a, the first portion of the desktop contains “Content A” and a “star” 424 which may represent electronic ink, graphics, a window, one or more electronic files, an icon, or any other data set or structure. The second portion of the desktop, which is displayed in region 416 of the first display device 402 and in region 418 of the second display device 404, contains “Content B” at this time. To move the star 424 from the first portion of the desktop to the second portion of the desktop, a user first selects the star 424 in a suitable manner, for example, through a block select action, a lasso select action, a tapping action, or the like, using an input device (such as pen 406, a mouse-type device, a keyboard, etc.). Then, the user “drags” the star 424 from the first portion of the desktop (region 414) to the second portion of the desktop (region 416) using the pen 406 (or other input device), as shown by arrow 426 in FIG. 7a. Once the star crosses the border and enters region 416, it has moved to the second portion of the desktop (and has left the first portion of the desktop), and it also appears in a corresponding location on the second display device in viewable region 418, as shown in FIG. 7b. Accordingly, as shown in FIGS. 7a and 7b, in this example, the content of the first portion of the desktop changes (original Content A, changed to Content A′ when the star 424 left), and the content of the second portion of the desktop also changes (original Content B, changed to Content B′ when the star 424 was added). In this manner, the content of external display device 404 can be controlled and modified using only the pen 406 (or other input device) and the computer system 410, even if display device 404 does not include a digitizer and cannot directly interact with pen 406.

Of course, rather than remove content from the first portion of the desktop to place in the second portion of the desktop (e.g., through the above-described type “move” action), content in the first portion of the desktop could be cut or copied and then pasted into the second portion of the without departing from the invention. New data also could be entered directly into the second portion of the desktop through region 416. Also, in a manner similar to that illustrated in FIGS. 7a and 7b, any desired data could be moved from the second portion of the desktop (represented by region 416) into the first portion of the desktop (represented by region 414), in which case, when moved or cut, the content also would disappear from region 418 on display device 404.

Any size “portal” could be made available to allow transfer of data between the two portions of the desktop. For example, in some instances, the entire viewable region 416 can be considered a “jump pane,” and data manipulation of any kind that occurs within the jump pane effectively occurs within the second portion of the desktop. As another example, data crossing into or out of the second region 416 may be allowed to take place only along one or more predetermined locations or edges of region 416 and/or along only a portion of one or more of these locations or edges. Additionally, the ability to use the jump pane and/or portal may be activated in any suitable manner without departing from the invention. For example, the portal and/or jump pane may be activated automatically any time a user enters a multi-monitor mode and/or extended desktop mode. As another example, if desired, the user may selectively activate the jump pane or portal by interacting with a user interface item, such as a button or menu item. Other suitable ways of activating and using the jump pane and/or portal also are possible without departing from the invention.

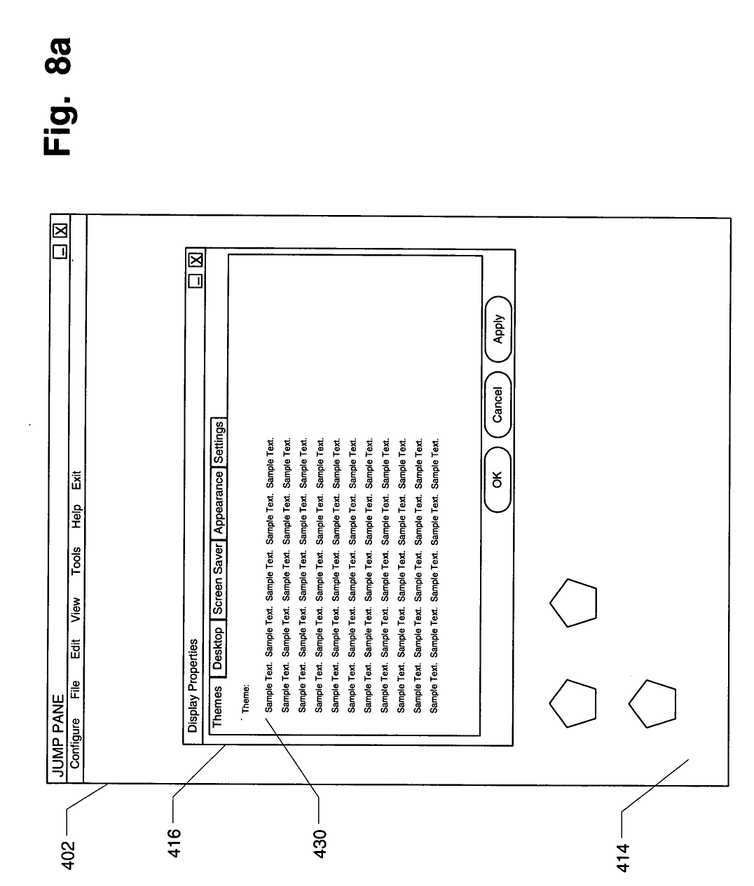

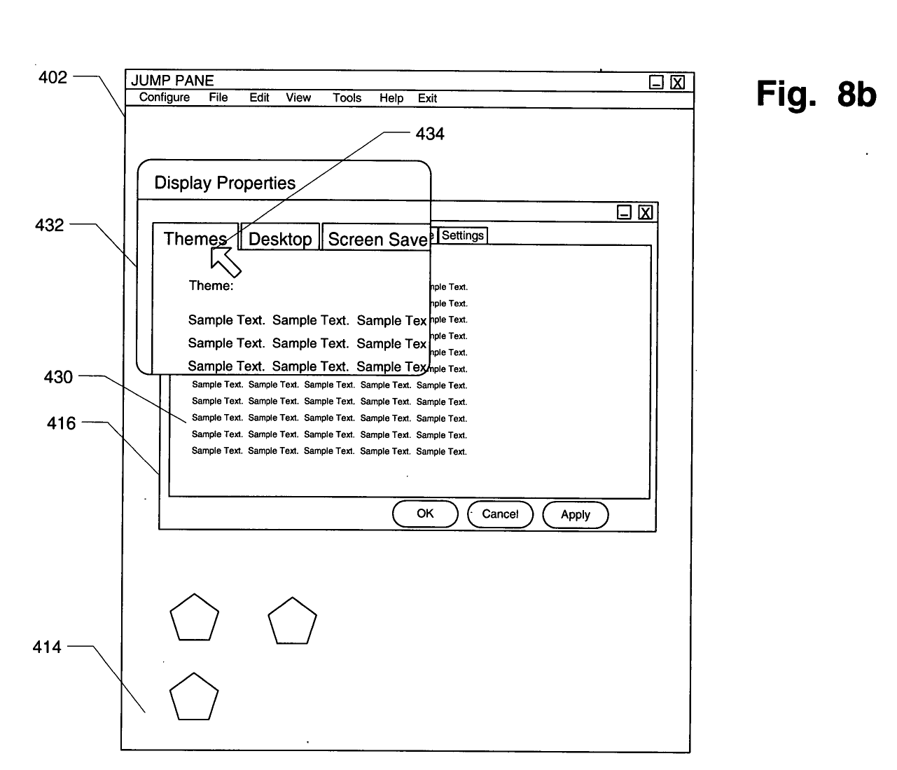

FIGS. 8a and 8b illustrate additional features available in at least some examples of systems and methods according to the invention. FIG. 8a illustrates a display device 402 on which a first portion 414 of a desktop is displayed and on which a representation of a second portion 416 of the desktop also is displayed. As evident from FIG. 8a, the desktop portions 414 and 416 contain different content. As noted above, the display device 402 may form a user input area for a pen-based computing system like those illustrated in FIGS. 4, 5, 6a, 6b, 6c, 7a, and 7b.

In many instances, pen-based computing systems like those described above contain relatively small display devices, in order to keep the computing system as small, lightweight, and mobile as possible. Small display devices of this type can be difficult for some users to see, particularly in the situation illustrated in which only a portion 416 of the display device 402 is intended to represent and display the entire content 418 of another display 404. In these situations, the content 430 on the represented display portion 416 can become quite small and difficult to understand. Accordingly, some example systems, methods, and user interfaces according to the invention may include a magnifier that enlarges at least some of the represented display portion. For example, as illustrated in FIG. 8b, when a pen, stylus, or other pointing device (such as a mouse, trackball, rollerball, or touchpad cursor without a button click, a hovering pen or stylus, or the like) is positioned over the represented display portion 416 on the first display device 402 (e.g., that portion of a desktop also displayed by another display device), the portion immediately below and/or surrounding the pointing device location is magnified, as shown by magnified content portion 432 in FIG. 8b. The location of the pointing device is shown in FIG. 8b by arrow 434. Any suitable cursor or indicator of the location of the pointing device in the magnified area 432 may be used without departing from the invention, including shading, different coloration, underlining, italicizing, bolding, highlighting, etc. Also, if desired, no cursor or location indicator is necessary. If desired, systems, methods, and user interfaces according to at least some examples of the invention can allow the user to interact with data contained in the magnified area 432, e.g., by tapping on it, clicking it, dragging it, etc.

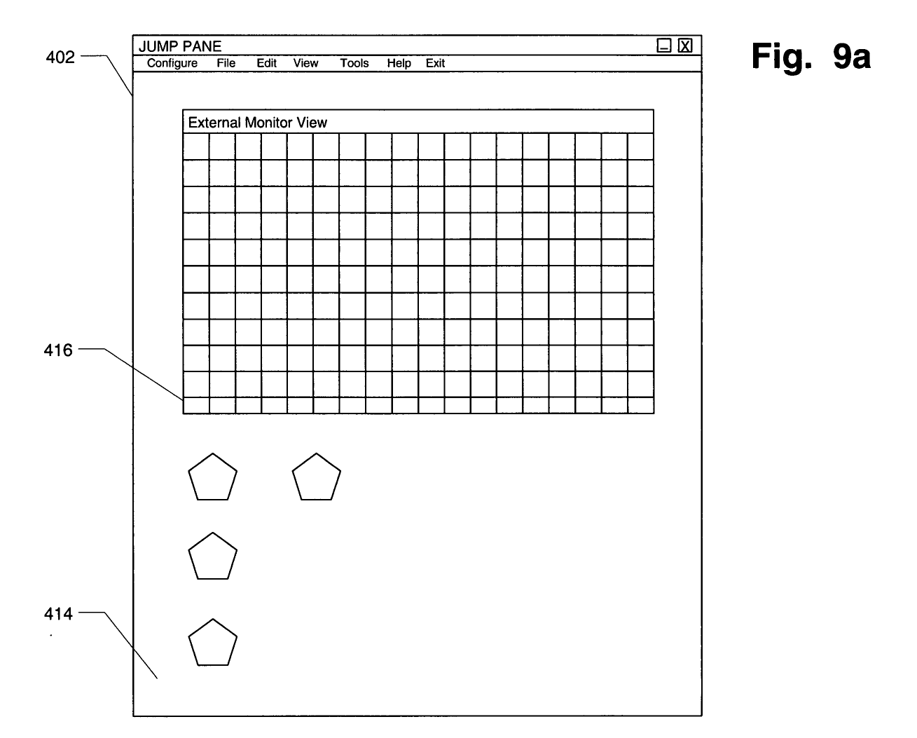

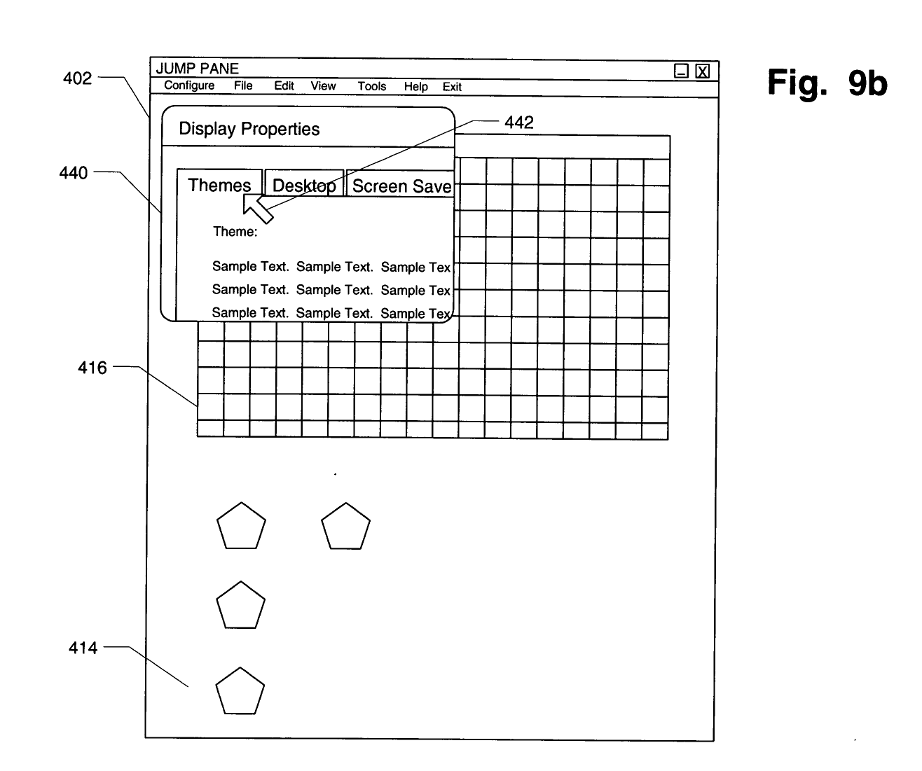

FIGS. 9a and 9b illustrate still additional features present in at least some examples of the invention. In some examples of the invention, like those illustrated in FIGS. 6a-6c, 7a-7b, and 8a-8b, the content of the represented display portion 416 on the first display device 402 mirrors the content of display portion 418 of the second display device 404. While this feature is advantageous, in some instances, it can cause difficulties. For example, if either one of the main computer processor or the graphics processor of the display device 402 is slow, users may experience substantial processing delays as data is entered, deleted, or modified in represented display portion 416. The presence of a large content volume in portions 416 and 418 can further slow processing associated with the display of graphics information by the display devices 402 and 404. These processing delays can be frustrating to users and can detrimentally impact the data entry procedures.

It is not necessary, however, in every instance, to fully mirror the content of the display portion 418 of display device 404 within the represented display portion 416 of display device 402. Rather, as illustrated in FIG. 9a, the display portion 418 of display device 404 may be represented in display portion 416 of display device 402 without reproducing all of the graphical information. For example, FIG. 9a illustrates the represented display portion 416 by display device 402 as a simple grid pattern without a graphical reproduction of the display portion 418 of display device 404 (display device 404 continues to display all information on this portion of the desktop). The full graphic display of desktop portion 414 remains on display device 402, as shown. In this manner, the computer and graphics processor(s) need not work to maintain a complete copy of the second display device 404 by the first display device 402, and the associated processing delays are avoided and/or reduced. While a grid pattern is shown in represented portion 416 in FIG. 9a, those skilled in the art will appreciate that any suitable display, or even no display, could be provided in represented portion 416 without departing from the invention.

In some examples of the system of FIG. 9a, users still could use display device 402 to view the data and information contained on display device 404. For example, as illustrated in FIG. 9b, when a pen, stylus, or other pointing device (such as a mouse, trackball, rollerball, or touchpad cursor without a button click, a hovering pen or stylus, or the like) is positioned over the represented display portion 416 on the first display device 402, the area immediately below and/or surrounding the location of the pointing device is displayed, as shown by displayed content portion 440 in FIG. 9b. The location of the pointing device is shown in FIG. 9b by arrow 442. As with the example shown in FIG. 8b, any suitable cursor or indicator of the location of the pointing device in the displayed area 440, or even no cursor or indicator, may be used without departing from the invention, including shading, different coloration, underlining, italicizing, bolding, highlighting, etc. If desired, systems, methods, and user interfaces according to some examples of the invention can allow the user to interact with data contained in the displayed area 440, e.g., by tapping on it, clicking it, dragging it, etc. Additionally, although not required, the displayed area 440 also may be magnified in some examples, as illustrated in FIG. 9b and discussed above in conjunction with FIG. 8b. As still another option, the entire represented region 416 could appear at any time a pointing device moves within region 416.

While the various examples described above specifically illustrate use of the invention with an electronic pen and one monitor provided as part of a pen-based computing system, these features are not required. For example, a mouse, touchpad, trackball, rollerball, eraser head, joystick, or other suitable user input devices could be used to enter, manipulate, and/or delete the data in the same general manner described above without departing from the invention. Additionally, a keyboard also could be used, in at least some examples and some situations, for user input entry without departing from the invention.

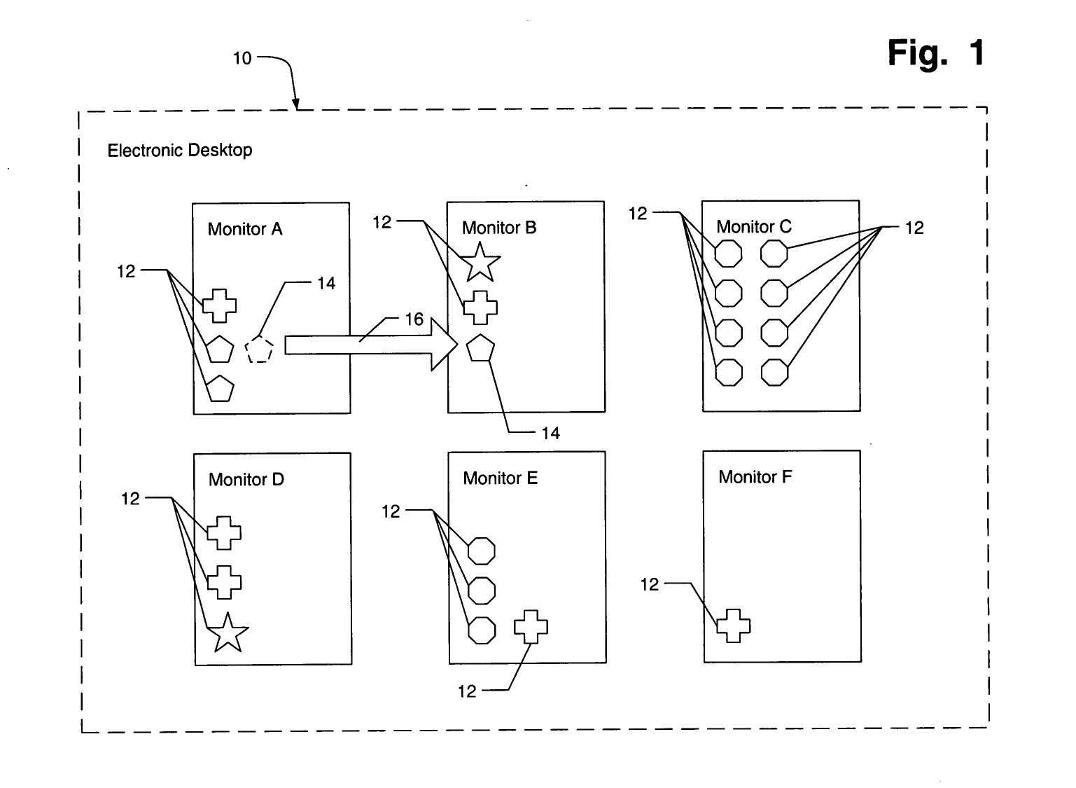

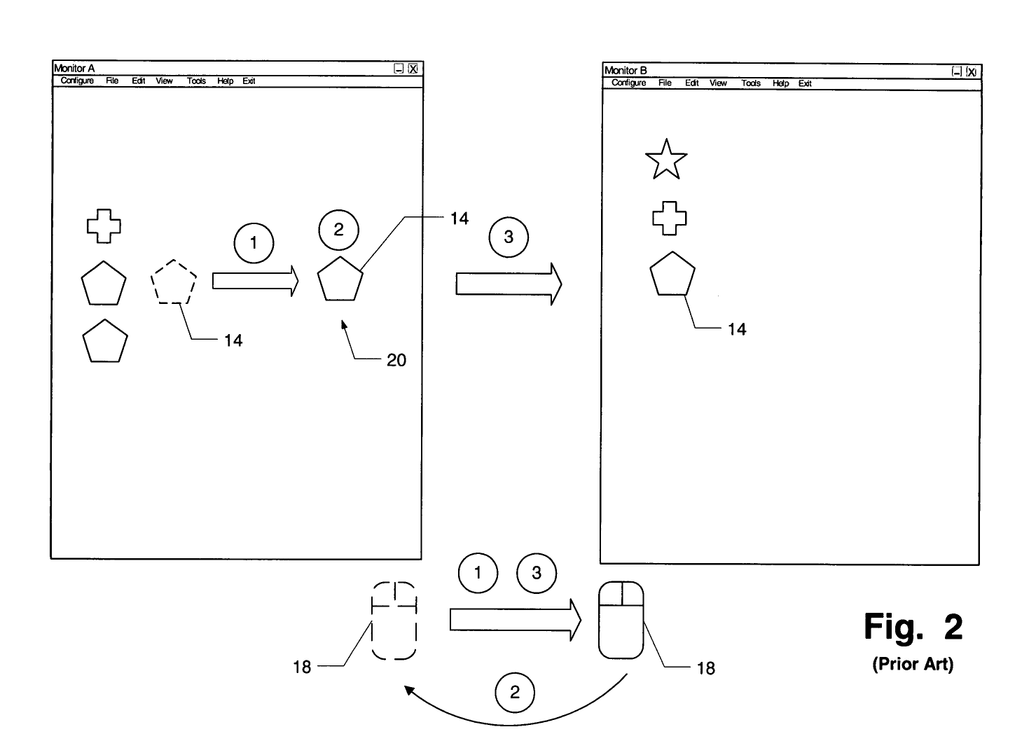

In some situations, however, it may be preferable to limit use of the jump pane or portal to only pen events. As described above, because an electronic pen is an absolute pointing device, the jump pane or portal according to examples of the invention advantageously allow data to be transferred to different portions of a desktop from the portion of the desktop displayed by a device displaying the first portion of the desktop. User input devices like a mouse, touchpad, rollerball and trackball, however, are relative pointing devices, not absolute pointing devices like a pen. Accordingly, on some systems in which a jump pane or portal is available, a mouse (or the like) can be used in the same manner described in FIGS. 1 and 2 to move data between different portions of the desktop. Accordingly, it is not absolutely necessary for mouse type devices (relative pointing devices) to take advantage of the jump pane and/or portal (although such input devices may be used with the jump pane or portal, if desired).

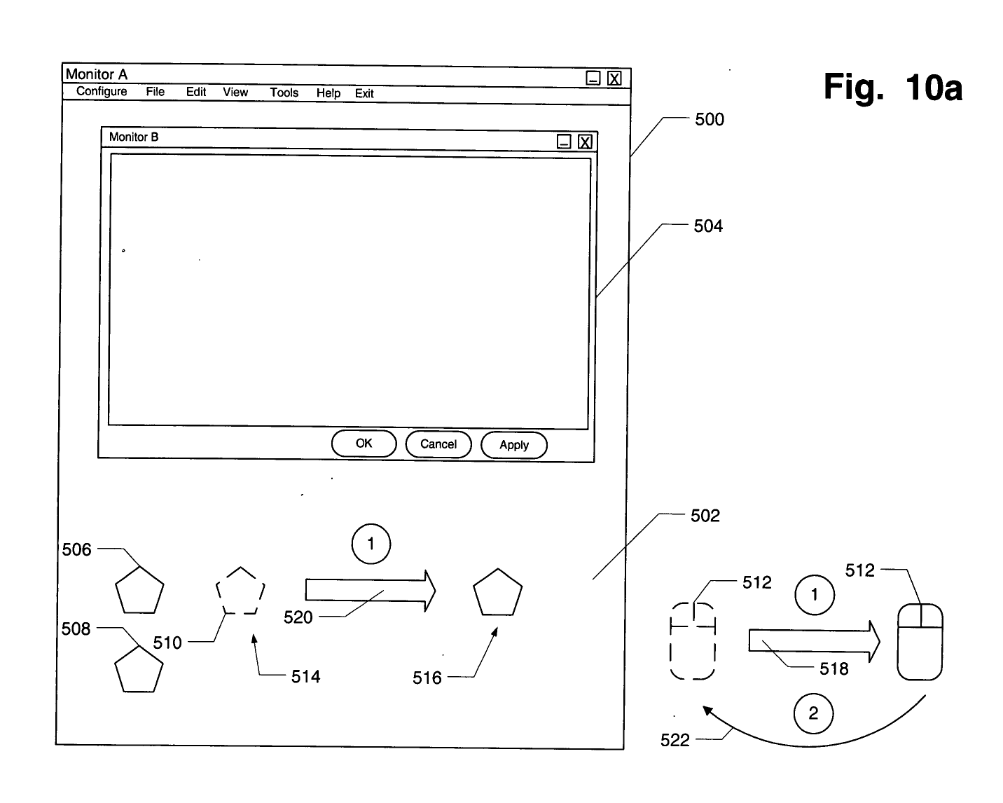

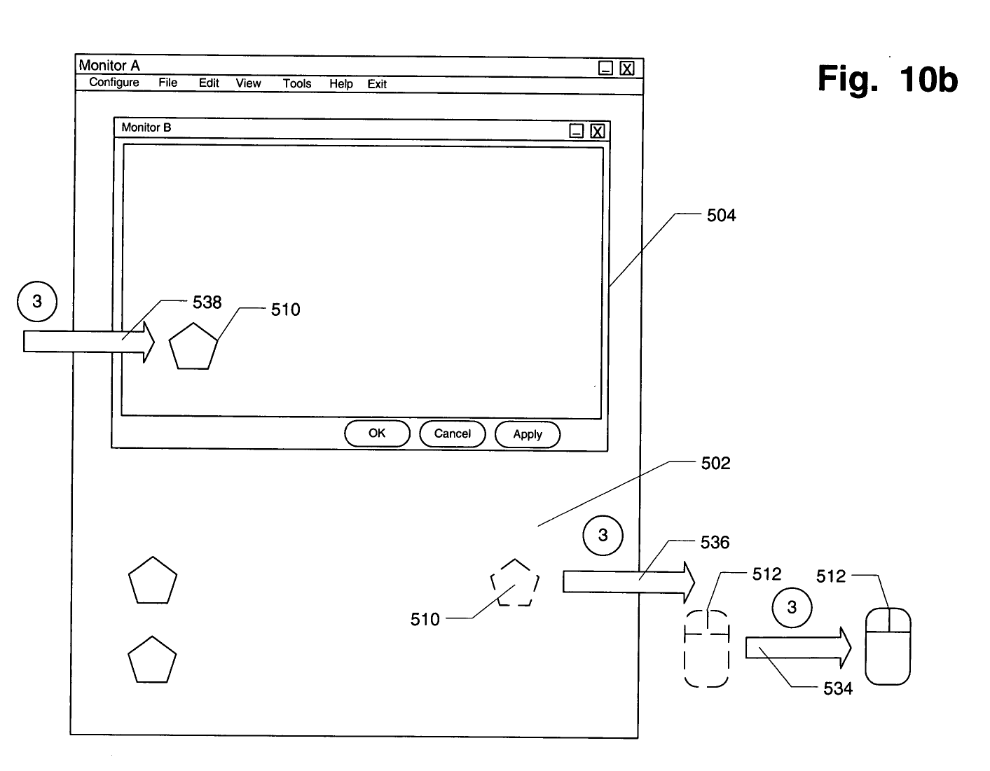

FIGS. 10a and 10b illustrate an example of a situation in which a mouse may be used to move data between portions of the desktop when the jump pane is open and available. Specifically, as illustrated in FIG. 10a, Monitor A 500 includes a first portion 502 of a desktop and a portion 504 representing a second portion of the desktop. The second portion 504 of the desktop also may be displayed by another monitor (Monitor B, not shown) that is separate from Monitor A 500, as described above. Three data structures (e.g., icons, electronic ink stroke(s), graphics, windows, files, or any other data structure) are included in the first portion 502 of the desktop, namely data structures 506, 508, and 510.

If the user desires to move data structure 510 from the first portion 502 of the desktop to the second portion using a mouse 512, he/she may do so by first moving the mouse 512 to the right as far as necessary to move the data structure 510 to the desired location. For example, in a first move, as shown in FIG. 10a, the user clicks on data structure 510 at its original location (location 514) and drags it to the right to location 516. In FIG. 10a, movement of the mouse 512 during the first step is illustrated by arrow 518, and the corresponding visual depiction of the data structure 510 movement is illustrated by arrow 520. If the initial movement is not sufficient to locate the data structure 510 at its desired final location, then in a second step, the mouse 512 may be lifted and moved to the left, as illustrated in FIG. 10a by arrow 522. Then, in a third step, as illustrated in FIG. 10b, the mouse 512 may be again moved to the right until the visual representation of the data structure 510 disappears from the first portion 502 of the desktop and appears in the representation of the second portion 504 of the desktop. In FIG. 10b, arrow 534 illustrates movement of the mouse 512 during the third step, and arrows 536 and 538 illustrate the corresponding movement of the visual representation of data structure 510. Notably, in this example, when all the movements are completed, the visual representation of data structure 510 is eliminated from the first portion of the desktop 502, and it is present only in the representation of the second portion 504.

If necessary, these steps may be repeated as often as necessary to place the visual representation of data structure 510 in the desired location on the desktop. Also, the direction of mouse and data structure movement may be different and freely selected (not necessarily left to right) without departing from the invention.

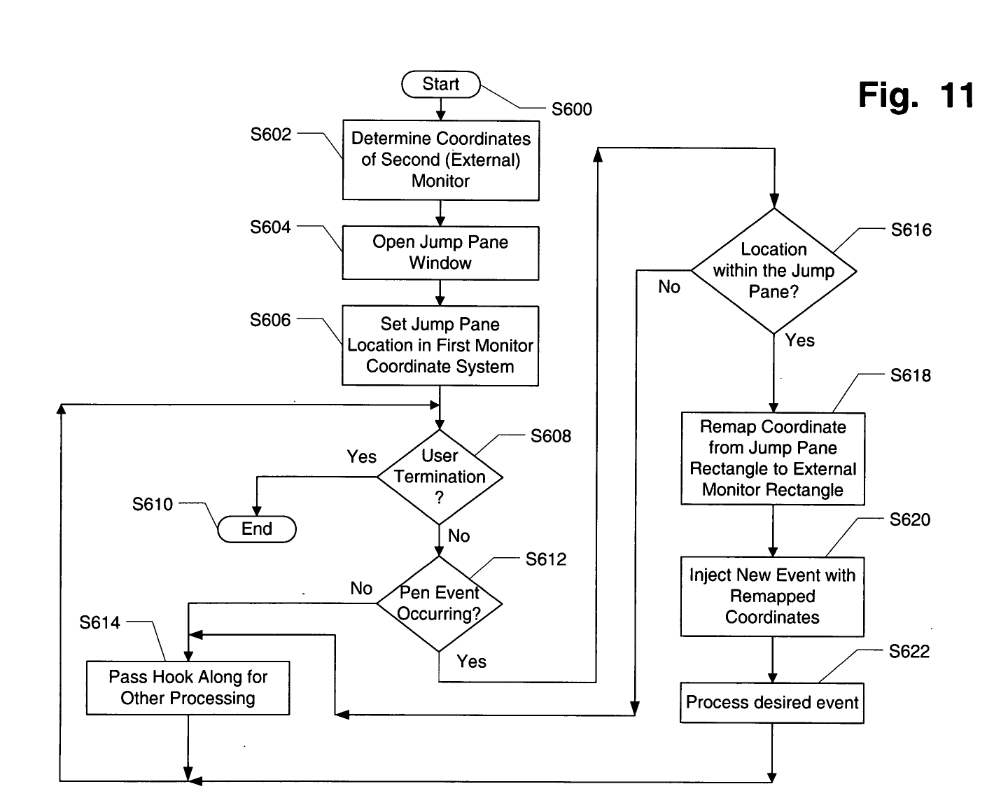

FIG. 11 illustrates a flow diagram of a low level user input device hook useful in systems and for performing methods according to at least some examples of this invention. For example, as described above, FIGS. 7a and 7b illustrate movement of a data structure and a visual representation of the data structure 424 from a first desktop portion 414 to a second desktop portion represented by region 416 on display device 402 and area 418 on display device 404 using a pen 406. The example method shown in FIG. 11 may be used in processing such an action.

As the procedure starts (S600), the coordinates of the secondary or external display device (e.g., display device 404 from FIGS. 7a and 7b) are determined (S602). This procedure can be started in any suitable manner without departing from the invention. For example, the procedure may be started in response to a user's command, automatically whenever a multi-monitor mode is activated, automatically whenever an extended desktop mode is activated, or the like.

Based on these coordinates determined at S602, a jump pane window (e.g., area 416) representing the secondary or external display is opened S604 within the device displaying a first portion of the desktop (e.g., display device 402 and desktop portion 414 in FIGS. 7a and 7b), and the jump pane window is properly located on that display device (S606). The external display device and its virtual representation on the other display device display a second portion of the desktop that is independent of the first portion of the desktop. The jump pane window 416 may be located at any suitable position on the display device 402 without departing from the invention, and, in at least some examples of the invention, its size and location may be freely selected and modified by the users. For example, the jump pane window could be initially located at a default, predetermined position and of a default, predetermined size (optionally at a position and/or size selected by the user). As another alternative, the jump pane window could be initially located and sized based on the location and size of the window the last time it was opened and/or used. Other options also are possible.

In the present example, only pen-based events may use the jump pane (i.e., in this example, mouse, trackball, touchpad, rollerball, or keyboard action cannot make use of the jump pane). Accordingly, at S608, systems and methods according to this example of the invention determine whether a user has terminated an input session (e.g., closed a document, timed out, quit, or otherwise stopped an application program or an input session). If “Yes,” the procedure ends (S610). If “No” at S608, systems and methods according to this example of the invention determine whether an input event is occurring and whether it involves user input through a pen (S612). If “No,” the user input hook processor is made available for other processing (S614), and the procedure returns to S608. In this example, attempts to use a mouse type device to move data through the jump pane can be treated in any suitable manner without departing from the invention. For example, the attempt can be ignored, and the visual representation of the data (if any) can be returned to its original location on the originating portion of the desktop.

If at S612, however, the system determines that the detected event is a pen-based event (answer “Yes”), the system next determines whether the event is located within the jump pane area of the system (e.g., the system determines whether the event is located within area 416 from FIGS. 7a and 7b) (S616). Again, if the answer is “No,” the user input hook processor is made available for other processing (S614), and the procedure returns to S608. If, however, at S616 the answer is “Yes,” at S618, systems and methods according to this example of the invention remap the coordinates from the jump pane area of the display device to the corresponding coordinates of the actual external display device (e.g., using the coordinates within area 416 of display device 402, the location of the event is mapped to the corresponding coordinates within display area 418 of display device 404).

Once the coordinates of the event on the external display device are determined at S618, the processor may inject the event into the external display device (e.g., display device 404 using the remapped coordinates), and if desired, into its representation in the jump pane (e.g., in area 416 of display device 402) (S620). All additional processing associated with the event (if any) may then be completed (S622) and the procedure will return to S608 (e.g., wait for the next event and/or a continuation of the present event).

Many variations on the above-described procedure may be made without departing from the spirit and scope of the invention. For example, the order of various steps may be changed, additional steps may be added, and certain steps may be modified and/or omitted without departing from the invention. As one more specific example, if all user input device events are able to use the jump pane (not just pen events), then S608 may be omitted.

As additional examples of variations, systems, methods, and user interfaces according to the invention could be used to maintain, view, and interact with more than two independent portions of the desktop. For example, a user could be working with three or even more portions of the desktop, optionally using three or more independent display devices, without departing from the invention. As another example variation, the invention may be used over suitable remote connections such that the display device displaying the first portion of the desktop is provided at a different location from the display device displaying the second portion of the desktop (which also displays the region representing the first portion of the desktop).

Another example use might include use of systems and methods according to the invention for a slide presentation wherein slides are presented to an audience on one display device and another display device (e.g., for the speaker) includes a visual representation of the specific slide being displayed and an area on which the speaker can make notes that are not displayed on the slide display device.

Finally, the present invention also relates to computer-readable media including computer-executable instructions stored thereon for performing the various methods and/or for use in the various systems described above. The computer-readable media may constitute computer-executable instructions stored on the various specific examples described above.

E. Conclusion

Various examples of the present invention have been described above, and it will be understood by those familiar with this art that the present invention includes within its scope all combinations and subcombinations of these examples. Additionally, those familiar with the art will recognize that the above examples simply exemplify various aspects of the invention. Various changes and modifications may be made without departing from the spirit and scope of the invention, as defined in the appended claims.

1. A method for providing a user interface, comprising:
providing a first viewable region capable of displaying a first portion of a desktop on a display device; and
providing a second viewable region capable of displaying a second portion of the desktop on the display device, wherein a portion of the first viewable region redirects data input to and associates the data input with the second portion of the desktop.

2. A method according to claim 1, further comprising:
accepting user input, wherein at least some of the user input includes the data input redirected to the second portion of the desktop.

3. A method according to claim 2, wherein the user input includes use of a pen.

4. A method according to claim 1, further comprising:
determining at least a first coordinate of the first viewable region associated with the data input to be redirected to the second portion of the desktop; and
remapping the first coordinate to a corresponding coordinate of the second portion of the desktop.

5. A method according to claim 1, wherein the first viewable region includes a data input region in which a user can enter data, wherein the data input region is outside of the portion in which the data input is redirected to the second portion of the desktop.

6. A method according to claim 1, further comprising:
moving data from the first portion of the desktop to the second portion of the desktop via the portion that redirects the data input to the second portion of the desktop.

7. A method according to claim 6, wherein a user input device moves the data from the first portion of the desktop to the second portion of the desktop.

8. A method according to claim 6, further comprising:
moving data from the second portion of the desktop to the first portion of the desktop via the portion that redirects the data input to the second portion of the desktop.

9. A method according to claim 1, further comprising:
moving data from the second portion of the desktop to the first portion of the desktop via the portion that redirects the data input to the second portion of the desktop.

10. A method according to claim 1, further comprising:
magnifying at least some content in the second viewable region when a pointing device points within the second viewable region.

11. A method according to claim 10, wherein the content magnified includes information associated with a location of the pointing device with the second viewable region.

12. A method according to claim 1, further comprising:
displaying at least some content in the second viewable region when a pointing device points within the second viewable region.

13. A method according to claim 12, wherein the content displayed includes information associated with a location of the pointing device with the second viewable region.

14. A computer-readable medium including computer-executable instructions stored thereon for performing the method of claim 1.

15. A method, comprising:
displaying a first portion of a desktop using a first display device;
displaying a second portion of the desktop using a second display device, wherein at least a portion of a display by the second display device includes a region representing the first display device; and
altering content displayed by the first display device in at least some instances based on data input directed to the region representing the first display device.

16. A method according to claim 15, wherein at least some data input directed outside the region representing the first display device does not affect the content displayed by the first display device.

17. A method according to claim 15, further comprising:
accepting user input as the data input directed to the region representing the first display device.

18. A method according to claim 17, wherein the user input includes use of a pen.

19. A method according to claim 15, further comprising:
determining at least a first coordinate of the second display device associated with the data input directed to the region representing the first display device; and
remapping the first coordinate to a corresponding coordinate of the first display device.

20. A method according to claim 19, wherein the content displayed by the first display device is altered at the corresponding coordinate based on the data input directed to the region representing the first display device.

21. A method according to claim 15, wherein the second portion of the desktop includes a data input region in which a user can enter data, wherein the data input region is outside of the region representing the first display device.

22. A method according to claim 21, wherein data directed to the data input region of the second portion of the desktop does not affect content displayed by the first display device.

23. A method according to claim 15, further comprising:
moving data from the second portion of the desktop to the first portion of the desktop via the region representing the first display device.

24. A method according to claim 23, wherein a user input device moves the data from the second portion of the desktop to the first portion of the desktop.

25. A method according to claim 23, further comprising:
moving data from the first portion of the desktop to the second portion of the desktop via the region representing the first display device.

26. A method according to claim 15, further comprising:
moving data from the first portion of the desktop to the second portion of the desktop via the region representing the first display device.

27. A method according to claim 15, further comprising:
magnifying at least a portion of content in the region representing the first display device when a pointing device points within the region representing the first display device.

28. A method according to claim 27, wherein the portion magnified includes information associated with a location of the pointing device with the region.

29. A method according to claim 15, further comprising:
displaying at least a portion of content in the region representing the first display device when a pointing device points within the region representing the first display device.

30. A method according to claim 29, wherein the portion displayed includes information associated with a location of the pointing device with the region.

31. A computer-readable medium including computer-executable instructions stored thereon for performing the method of claim 15.

32. A method, comprising:
maintaining a first portion of a desktop;
maintaining a second portion of the desktop, wherein the second portion of the desktop includes a region representing the first portion of the desktop; and
altering content of the first or second portions of the desktop in at least some instances based on data input directed to the region.

33. A method according to claim 32, wherein at least some data input directed to the second portion of the desktop outside the region does not affect the content of the first portion of the desktop.

34. A method according to claim 32, further comprising:
accepting user input as the data input directed to the region.

35. A method according to claim 34, wherein the user input includes use of a pen.

36. A method according to claim 32, further comprising:
determining at least a first coordinate of the second portion of the desktop associated with the data input directed to the region; and
remapping the first coordinate to a corresponding coordinate in the first portion of the desktop.

37. A method according to claim 36, wherein the content of the first portion of the desktop is altered at the corresponding coordinate based on the data input directed to the region representing the first portion of the desktop.

38. A method according to claim 32, wherein the second portion of the desktop includes a data input region in which a user can enter data, wherein the data input region is outside of the region.

39. A method according to claim 32, further comprising:
moving data from the second portion of the desktop to the first portion of the desktop via the region.

40. A method according to claim 39, further comprising:
moving data from the first portion of the desktop to the second portion of the desktop via the region.

41. A method according to claim 32, further comprising:
moving data from the first portion of the desktop to the second portion of the desktop via the region.

42. A method according to claim 32, further comprising:
displaying a magnified view of at least a portion of the first portion of the desktop in the second portion of the desktop when a pointing device points within the region.

43. A method according to claim 32, further comprising:
displaying at least a portion of the first portion of the desktop in the second portion of the desktop when a pointing device points within the region.

44. A computer-readable medium including computer-executable instructions stored thereon for performing the method of claim 32.

45. A system, comprising:
a first display device displaying a first portion of a desktop;
a second display device displaying a second portion of the desktop, wherein at least a portion of a display by the second display device includes a region representing the first display device; and
a processor programmed and adapted to alter content displayed by the first display device in at least some instances based on data input directed to the region representing the first display device.

46. A system according to claim 45, wherein at least some data input directed outside the region representing the first display device does not affect the content displayed by the first display device.

47. A system according to claim 45, further comprising:
an input receiver for accepting user input, wherein at least some of the user input includes the data input directed to the region representing the first display device.

48. A system according to claim 45, wherein the processor further is programmed and adapted to: (a) determine at least a first coordinate of the second display device associated with the data input directed to the region representing the first display device, and (b) remap the first coordinate to a corresponding coordinate of the first display device.

49. A system according to claim 48, wherein the processor is further programmed and adapted to alter the content displayed by the first display device at the corresponding coordinate based on the data input directed to the region representing the first display device.

50. A system according to claim 45, wherein the second portion of the desktop includes a data input region in which a user can enter data, wherein the data input region is outside of the region representing the first display device.

51. A system according to claim 50, wherein data directed to the data input region of the second portion of the desktop does not affect content displayed by the first display device.

52. A system according to claim 45, wherein the processor further is programmed and adapted to move data from the second portion of the desktop to the first portion of the desktop via the region representing the first display device.

53. A system according to claim 52, further comprising:
a user input device for indicating the data to move from the second portion of the desktop to the first portion of the desktop.

54. A system according to claim 45, wherein the processor is further programmed and adapted to move data from the first portion of the desktop to the second portion of the desktop via the region representing the first display device.

55. A system according to claim 45, wherein the processor is further programmed and adapted to magnify at least a portion of content in the region representing the first display device when a pointing device points within the region representing the first display device.

56. A system according to claim 45, wherein the processor is further programmed and adapted to display at least a portion of content in the region representing the first display device when a pointing device points within the region representing the first display device.

57. A system, comprising:
a receiver constructed and adapted to receive input; and
a processor programmed and adapted to: (a) maintain a first portion of a desktop; (b) maintain a second portion of the desktop, wherein the second portion of the desktop includes a region representing the first portion of the desktop; and (c) alter content of the first or second portion of the desktop in at least some instances based on data input directed to the region.

58. A system according to claim 57, wherein at least some data input directed to the second portion of the desktop outside the region does not affect the content of the first portion of the desktop.

59. A system according to claim 57, wherein the receiver accepts user input, wherein at least some of the user input includes the data input directed to the region.

60. A system according to claim 57, wherein the processor is further programmed and adapted to: (d) determine at least a first coordinate of the second portion of the desktop associated with the data input directed to the region, and (e) remap the first coordinate to a corresponding coordinate in the first portion of the desktop.

61. A system according to claim 60, wherein the processor is further programmed and adapted to alter the content of the first desktop at the corresponding coordinate based on the data input directed to the region.

62. A system according to claim 57, wherein the second portion of the desktop includes a data input region in which a user can enter data, wherein the data input region is outside of the region.

63. A system according to claim 57, wherein the processor is further programmed and adapted to move data from the second portion of the desktop to the first portion of the desktop via the region.

64. A system according to claim 57, wherein the processor is further programmed and adapted to move data from the first portion of the desktop to the second portion of the desktop via the region.

65. A system according to claim 57, wherein the processor is further programmed and adapted to produce a magnified view of at least a portion of the first portion of the desktop in the second portion of the desktop when a pointing device points within the region.

66. A system according to claim 57, wherein the processor is further programmed and adapted to produce a display of at least a portion of the first portion of the desktop in the second portion of the desktop when a pointing device points within the region.

67. A system according to claim 57, further comprising:
a first display device for displaying the first portion of the desktop.

68. A system according to claim 67, further comprising:
a second display device for displaying the second portion of the desktop.

69. A system according to claim 57, further comprising:
a display device for displaying the second portion of the desktop.

70. A user interface displayed by a display device, comprising:
a first region representing a first portion of a desktop;
a second region representing a second portion of the desktop; and
a data transfer path that allows data to be transferred between the first region and the second region.

71. A user interface according to claim 70, wherein the first region includes a data input region in which a user can enter data.

72. A user interface according to claim 71, wherein data directed to the data input region does not affect content of the second region.

73. A user interface according to claim 70, wherein when a pointing device points within at least one of the first region or the second region, a magnified view of at least a portion of the first region or the second region is displayed.

74. A user interface according to claim 73, wherein the portion displayed includes information associated with a location of the pointing device.

75. A user interface according to claim 70, wherein when a pointing device points within at least one of the first region or the second region, at least a portion of the first region or the second region is displayed.

76. A user interface according to claim 75, wherein the portion displayed includes information associated with a location of the pointing device.
